(19) United States
(12) Patent Application Publication
(10) Pub. No.: US 2014/0318009 A1
(43) Pub. Date: Oct. 30, 2014

(54) LOSS-IN-WEIGHT CONTROL FOR SEED TREATING EQUIPMENT

(71) Applicant: USC, L.L.C., Sabetha, KS (US)

(72) Inventors: Lynn E. Strahm, Sabetha, KS (US); Daniel M. Tramp, Sabetha, KS (US); Andy Renyer, Sabetha, KS (US); Jim Renyer, Sabetha, KS (US); Greg Renyer, Sabetha, KS (US); Timothy A. Craft, Holton, KS (US)

(73) Assignee: USC, L.L.C., Sabetha, KS (US)

(21) Appl. No.: 14/262,201

(22) Filed: Apr. 25, 2014

Related U.S. Application Data
(60) Provisional application No. 61/816,626, filed on Apr. 26, 2013.

(51) Int. Cl. B65D 88/54; A01C 1/06

(52) U.S. Cl. CPC B65D 88/54; A01C 1/06; B65D 2588/54
USPC 47/57.6; 414/288; 414/304

(57) ABSTRACT

A particulate material treating system (458) includes a loss-in-weight particulate material bin assembly (460), a particulate material metering device (462), and a downstream treater (464) yielding a treated material output (468). A controller (470) is employed to determine the flow rates of material from the bin assembly (460) using loss-in-weight calculations, and this information is used to at least in part control the operation of the metering device (462).

### CROSS-RELATED APPLICATIONS

This is a non-provisional application that claims the benefit of U.S. Patent Application Ser. No. 61/816,626 filed Apr. 26, 2013, which is incorporated herein by reference in its entirety.

### BACKGROUND OF THE INVENTION

1. Field of the Invention

The present invention is directed to improved metering assemblies for particulate materials, and especially seeds, permitting accurate, on-the-go control of the flow of particulates, so as to substantially constantly deliver an accurate flow rate of the particulates for downstream processing. More particularly, the invention is concerned with such metering assemblies wherein a metering device, such as a seed wheel assembly or rotatable seed gate assembly, are controlled at least in part by means of an upstream weigh bin providing continuous loss-in-weight information.

2. Description of the Prior Art

Agricultural seeds are commonly treated with various growth-promoting agents (e.g., pesticides and disease controlling materials) or the like. Seed treating assemblies generally include a lower seed treater with a seed supply tower above the treater designed to provide a continuous supply of seed to the latter. The tower typically has an uppermost seed bin with a surge bin below the seed bin, with the surge bin oriented to deliver seed to the treater. In practice, seed is conveyed by an inclined conveyor belt to the upper seed bin, which then feeds the surge bin. One type of low-profile seed bin of improved design is illustrated in U.S. Pat. No. 8,177,095.

A seed metering device is provided between the seed hopper and seed coating device, in an effort to give a substantially constant output flow of seeds to the coating device. However, some prior seed metering devices are prone to surging and inconsistent seed flow, which can lead to over- and undercoating of seeds. The problem of seed surging is significant because the usage rate of coating materials normally does not vary once the treater reaches a steady state condition.

Accordingly, when a surge occurs, the quantity of seed delivered to the coater may not be matched with the supply and application rates of the coating chemicals, leading to inconsistent seed coating. Therefore, the seed treater necessarily produces substantial quantities of under-coated seeds.

In many cases, a rotatable “seed wheel” is used as a metering device. Such wheels consist of a central hub with outwardly extending, radial arms and an outermost circular rim. In order to use such prior seed wheels, it has been necessary to determine a “cup rate” of seed by manually inserting a cup of known volume into the flow of seed, in order to calculate the seed flow rate in pounds per minute. This cup rate is then programmed into a seed wheel controller as an initial flow rate, which is then adjusted as seed coating is initiated and continues. However, this is objectionable to many processors, because of the time and trouble involved in changing the original cup rate. There is accordingly a need in the art for improved techniques for controlled flow of seeds delivered to a downstream coating device, without the need for cup rate determinations or other troublesome and time-consuming preliminary steps.

### SUMMARY OF THE INVENTION

The present invention overcomes the problems outlined above and provides a means of accurate flow rate control of particulate materials during treatment thereof. To this end, a particulate material weigh bin assembly is provided equipped with weighing device(s) permitting continuous or semi-continuous calculation of loss-in-weight data during delivery of particulate material from the bin assembly. This loss-in-weight data is then used to at least in part control the operation of a downstream metering device, such as a particulate wheel or a rotary gate assembly. The invention thus provides accurate particulate flow rate control, which is automatically adjusted over time. The invention is particularly concerned with seed treating systems, wherein agricultural seeds are coated with various liquid coatings.

Thus, a particulate material treating system in accordance with the invention generally comprises a loss-in-weight bin assembly operable to deliver particulates at known flow rates over time from a bin assembly output. The overall system further includes a particulate metering device operably coupled with the bin assembly output for metering the flow of the material therethrough, and a particulate material treater downstream of said metering device and operable to receive particulate material therefrom. In preferred forms, the bin assembly comprising a plurality of individual bins so as to provide a batch-continuous flow of the particulate material. In the context of seed treatment, a seed metering wheel or rotatable gate apparatus may be used as the metering device, and the downstream treatment device is a seed coater.

The invention also provides an improved method of treating particulate material which includes the steps of establishing a flow of particulate material from a particulate material bin assembly, and determining the flow rates of the material from the bin assembly over time as a function of the loss of weight of the bin assembly. In the next step, the flow of particulate material from the bin assembly is metered using a metering device to establish a constant flow rate of the material over time. This constant flow rate of material is then treated to yield a final product.

### BRIEF DESCRIPTION OF THE DRAWINGS

FIG. 1 is a schematic, exploded representation of one embodiment of the invention, making use of a seed metering wheel as the intermediate adjustable feeding device between a weigh bin assembly and a seed treater;

FIG. 2 is a schematic, exploded representation of another embodiment of the invention, making use of a controlled rotary gate assembly as the intermediate adjustable feeding device between a weigh bin and a seed treater;

FIG. 3 is a perspective view of the embodiment of FIG. 1, illustrating a manually controlled, lever-operated rotary gate assembly below the seed wheel assembly;

FIG. 4 is a fragmentary side elevational view of a preferred seed bin assembly forming a part of the invention;

FIG. 5 is a plan view of the seed bin assembly of FIG. 4;

FIG. 6 is a bottom view of the seed bin assembly of FIG. 4;

FIG. 7A is a fragmentary vertical sectional view of the seed bin assembly, illustrating in detail the construction of the upper turret assembly;

FIG. 7B is a fragmentary vertical sectional view illustrating in detail the outlet assembly of the seed bin assembly;

FIG. 8 is an exploded perspective view of the seed bin assembly;

FIG. 9 is an exploded perspective view of the upper turret assembly of the seed bin assembly;

FIG. 10 is a fragmentary plan view of the seed bin assembly, with the top wall of the turret assembly removed;

FIG. 11 is a perspective view of the turret assembly, illustrating the spring-biased seal plate at the outlet of the turret assembly;

FIG. 12 is a perspective view of a single bin forming a part of the overall bin assembly;

FIG. 13 is a fragmentary perspective view of an outlet of one of the bins of the seed bin assembly;

FIG. 14 is an exploded perspective view of the outlet illustrated in FIG. 13;

FIG. 15 is an elevational view of a seed wheel assembly in accordance with the invention;

FIG. 16 is a perspective view of a seed treater apparatus having the seed metering wheel assembly of the invention mounted thereon;

FIG. 17 is a perspective view of the seed metering wheel assembly and seed delivery shoot forming a part of the seed treater apparatus;

FIG. 18 is a plan view of the apparatus illustrated in FIG. 17;

FIG. 19 is a vertical sectional view taken along the line 19-19 of FIG. 18;

FIG. 20 is a vertical sectional view taken along the line 20-20 of FIG. 18;

FIG. 21 is a top perspective view of the preferred seed metering wheel assembly of the invention;

FIG. 22 is a bottom perspective view of the seed metering wheel assembly illustrated in FIG. 21;

FIG. 23 is a perspective view of another seed metering wheel design in accordance with the invention;

FIG. 24 is a plan view of the seed metering wheel of FIG. 23;

FIG. 25 is an upper, perspective, exploded view depicting the components of the seed metering wheel of FIG. 23;

FIG. 26 is a lower, perspective, exploded view depicting the components of the seed metering wheel of FIG. 23;

FIG. 27 is a vertical, sectional view taken along line 27-27 of FIG. 24;

FIG. 28 is a vertical, sectional view taken along line 28-28 of FIG. 24;

FIG. 29 is a vertical, sectional view taken along line 29-29 of FIG. 24;

FIG. 30 is a top view illustrating the seed metering wheel of FIG. 23 within the overall metering assembly;

FIG. 31 is a prospective view of a preferred metering gate assembly illustrated in FIG. 2;

FIG. 32 is a plan view of the metering gate assembly;

FIG. 33 is an end view of the metering gate assembly;

FIG. 34 is a side elevational view of the metering gate assembly;

FIG. 35 is a vertical sectional view along line 35-35 of FIG. 32;

FIG. 36 is a view taken along line 36-36 of FIG. 32;

FIG. 37 is an enlarged fragmentary view taken along line 37-37 of FIG. 36;

FIG. 38 is an enlarged fragmentary view depicting the drive cylinder for the metering gate assembly; and

FIG. 39 is a high-level schematic diagram illustrating the controlled operation of a seed treating system in accordance with the invention.

### DETAILED DESCRIPTION OF THE PREFERRED EMBODIMENT

The present invention provides a method of apparatus for improved, highly accurate control of the amount of particulate material, especially seeds, which are delivered from a weigh bin to a downstream treater device. In the ensuing discussion, reference will be made to flow control of seeds, but it is to be understood that the invention is applicable for flow control of all types of particulate materials; likewise, the downstream treater device is exemplified by a seed treater, but a variety of different treatment apparatus may be used with different types of particulates.

Generally speaking, the invention makes use of a weigh bin assembly having one or more seed bins each equipped with a full open/full closed valve or gate at the outlet thereof, together with a downstream seed treater of conventional design. An adjustable feeder device is located between the bin(s) outlet(s) and the inlet of the seed treater.

The weigh bin assembly includes appropriate weighing devices to continuously determine the weight of seeds within the bin assembly, typically in the form of one or more load cells supporting the seed bin(s). This allows continuous determination over time of the loss of weight in the bin(s). The intermediate adjustable feeder device is preferably in the form of a rotatable seed wheel or a rotary gate, which receives seed from the weigh bin assembly. The calculated loss in weight from the weigh bin assembly is used at least in part to control the operation of the adjustable feeder device, to thereby continuously maintain a desired gravimetric flow rate (lbs/min.) of seed to the inlet of the seed treater. This information is then used to match the flow of seed treatment liquid to the seed treater, so that the seeds being processed are evenly coated throughout a given seed treating run.

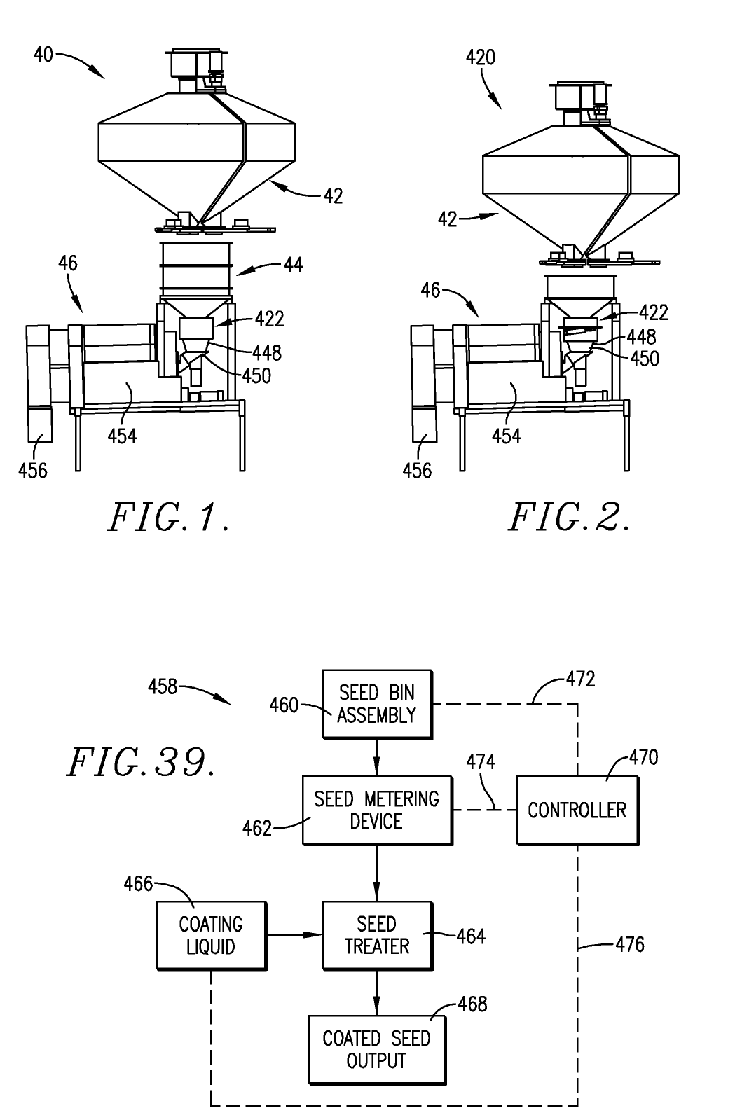

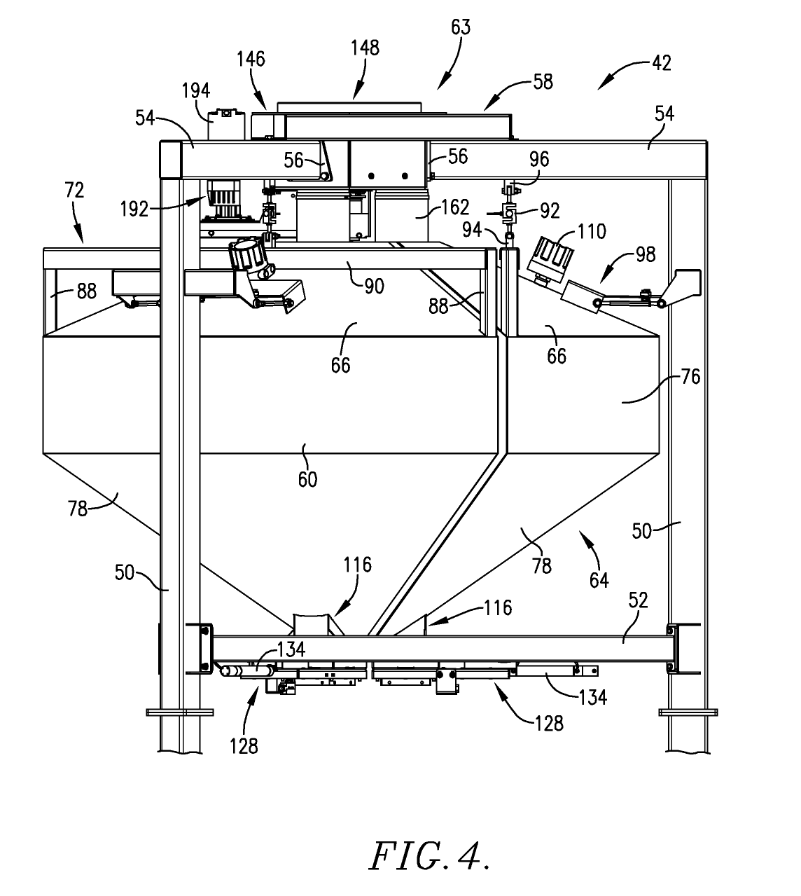

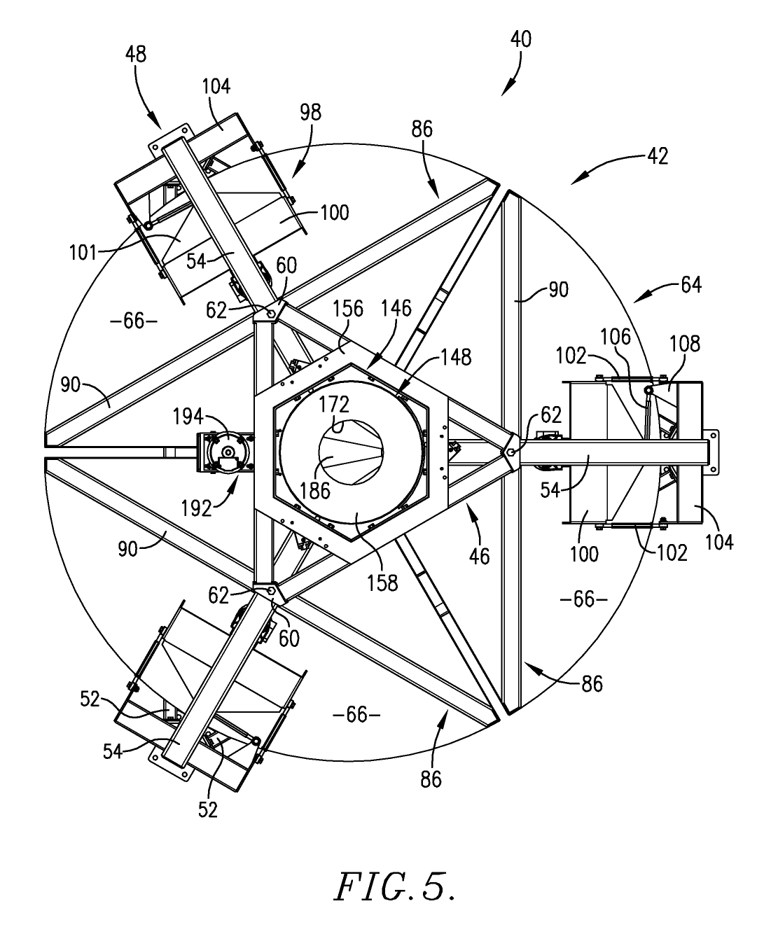

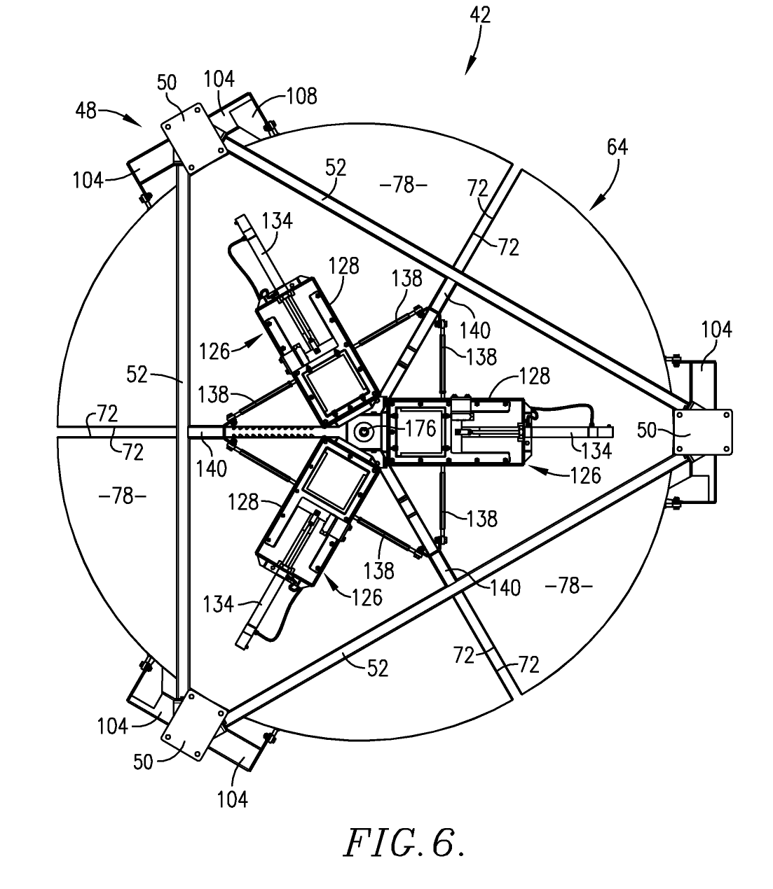

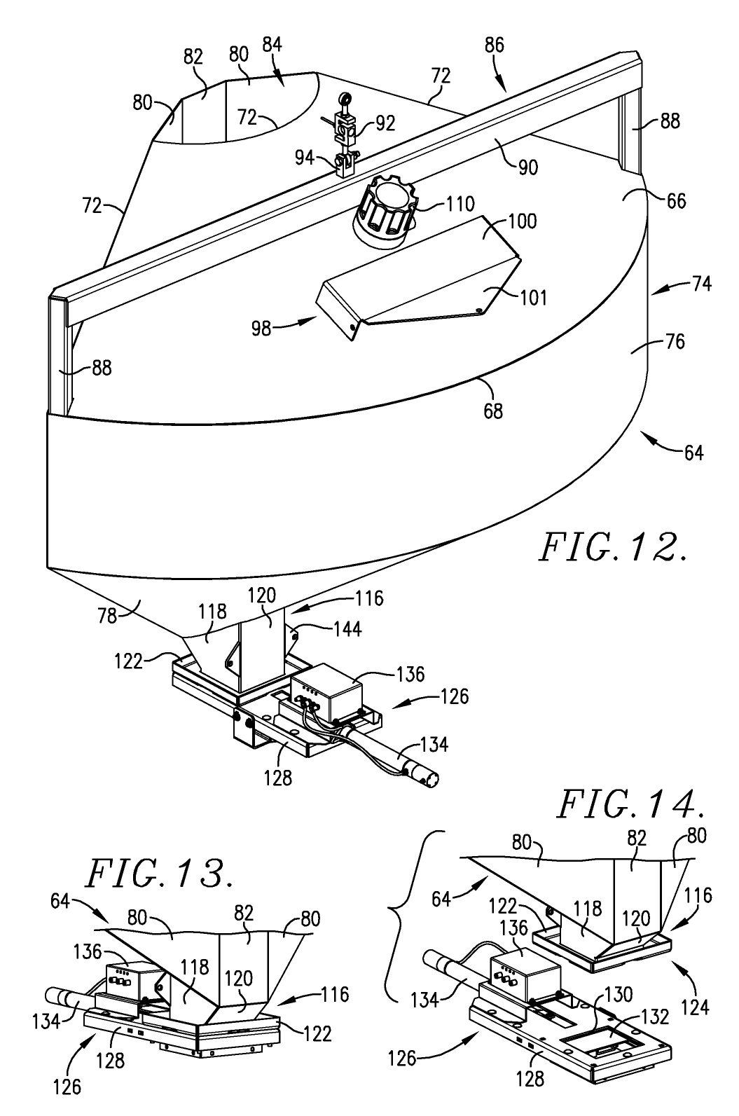

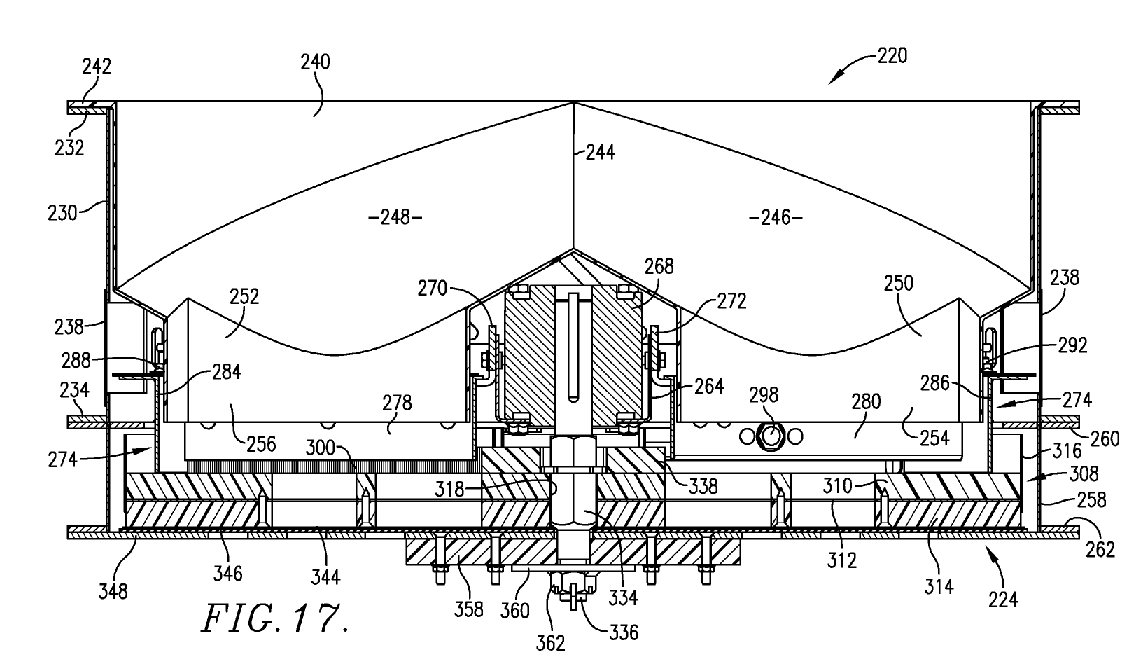

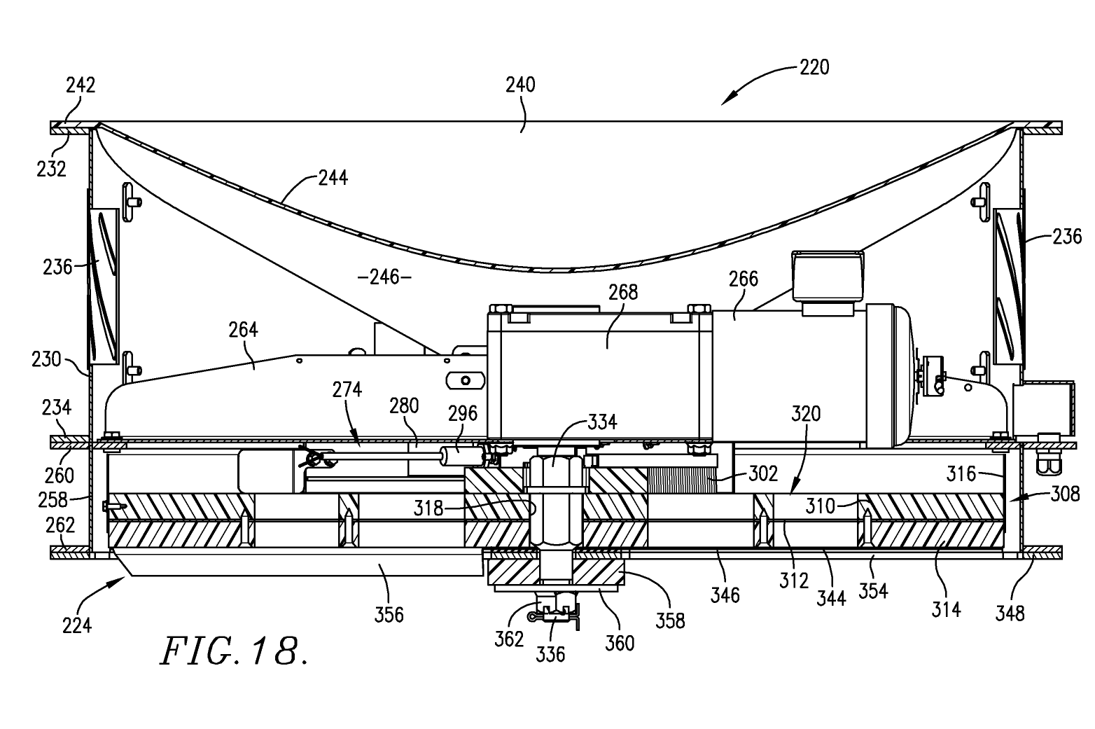

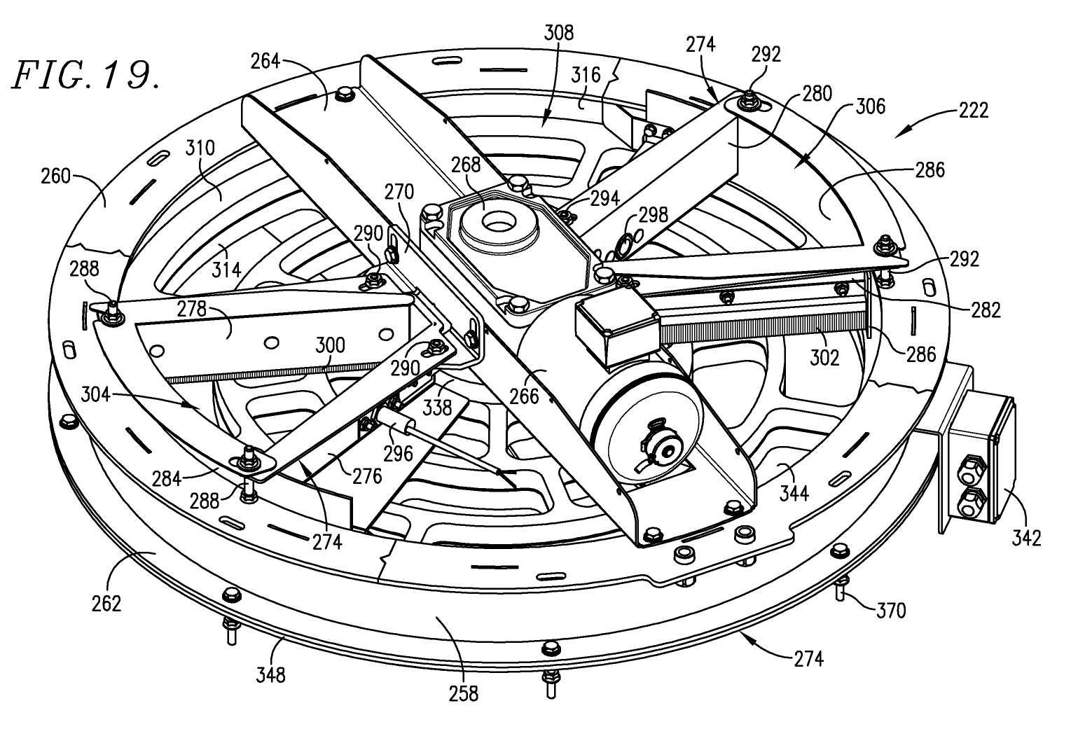

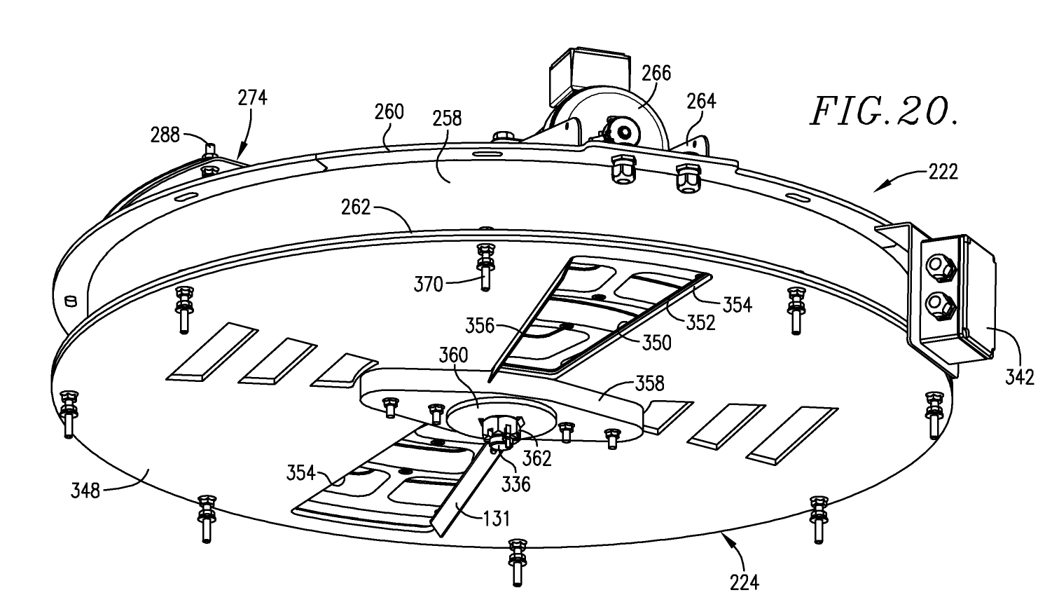

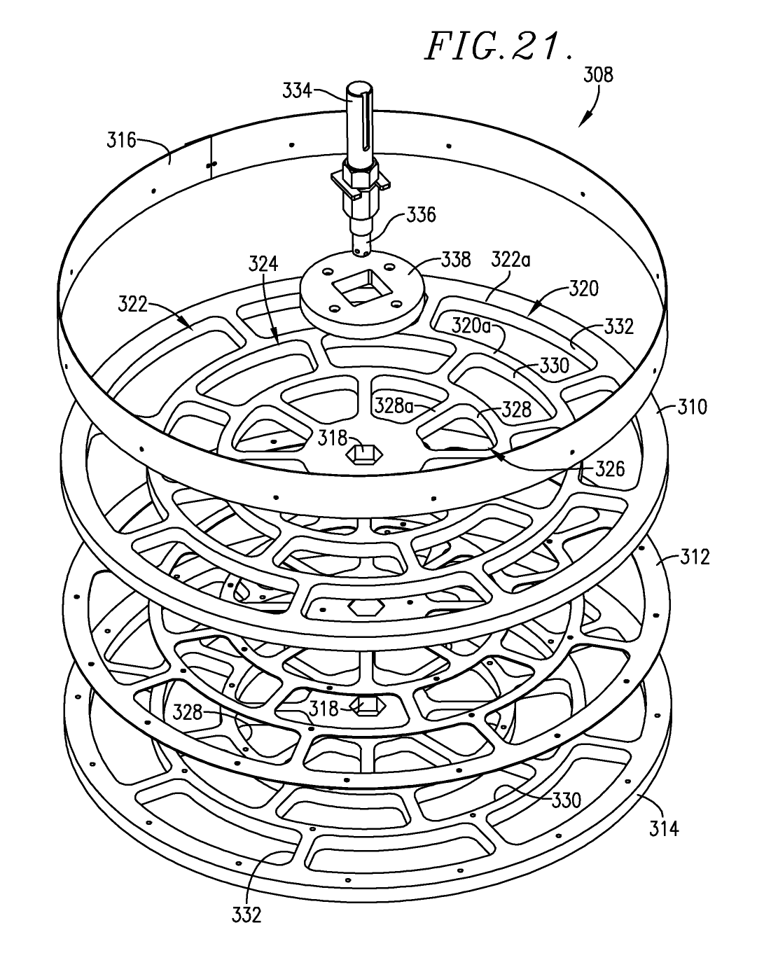

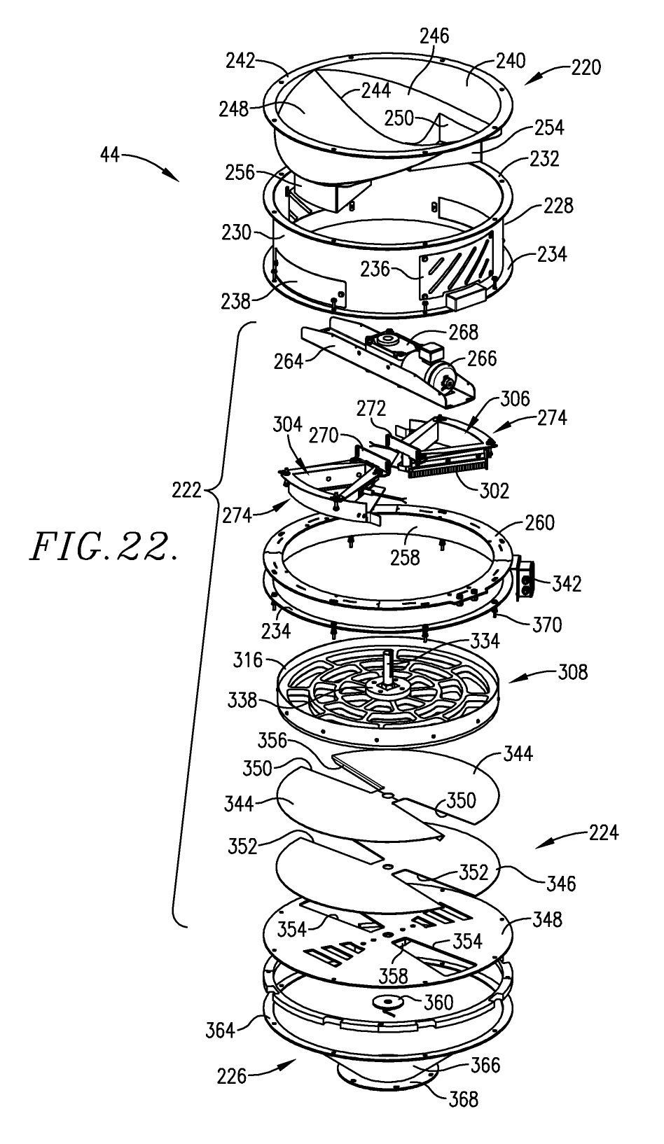

### Embodiment of FIGS. 1, 3 and 4-22

Turning first to FIG. 1, a loss-in-weight seed treating system 40 is illustrated, which broadly includes an upper multiple-bin seed bin assembly 42, an intermediate seed wheel assembly 44, and a lowermost seed treater 46. As is evident from these drawings, seed deposited into bin assembly 42 passes in serial order through the seed wheel assembly 44 and is ultimately treated within treater 46 before passing from the system.

Seed Bin Assembly 42

The assembly 42 generally includes frame structure 48 having three equidistantly spaced, upright, sectionalized support legs 50 with intermediate cross-braces 52 extending between the legs 50. An inwardly extending support beam 54 is secured to the upper end of each of the legs 50 and has an innermost apertured connection plate 56. A triangular turret frame 58 having apex-mounted, apertured connection flanges 60 is positioned atop and secured to the midpoints of the beams 54 by means of threaded connectors 62 extending through the flanges 60 and beams 54. The turret frame 58 in turn supports a turret assembly 63.

The frame 48 supports a total of three individual bins 64, with each such bin including a top wall 66 presenting an outermost arcuate margin 68 and an inner margin 70, and a pair of inwardly extending, converging side margins 72. Each top wall 66 is a truncated conical sector. Accordingly, each top wall 66 in plan configuration approximates a sector of a circle, and particularly a 120° section. In preferred forms, the top wall 66 is not a complete sector, but is truncated by the inner margin 70. Each bin 64 also has depending sidewall structure 74 including an arcuate upper section 76 depending from arcuate margin 68, and an inwardly tapered arcuate lower section 78 extending from the lower margin of section 76. Each section 78 is also a conical sector, so that in a bottom view, the sections 78 are in the shape of a proximate sector of a circle.

A pari of upright, substantially planar sidewalls 80 depend from the side margins 72. The inboard ends of the sidewalls 80 are interconnected by means of a planar segment 82. The top wall 66 and sidewall structure 74 are interconnected in order to define a seed-holding interior space. The inner margin 70 of top wall 66 and the upper margins of the sidewalls 80 and segment 82 cooperatively define a seed inlet 84.

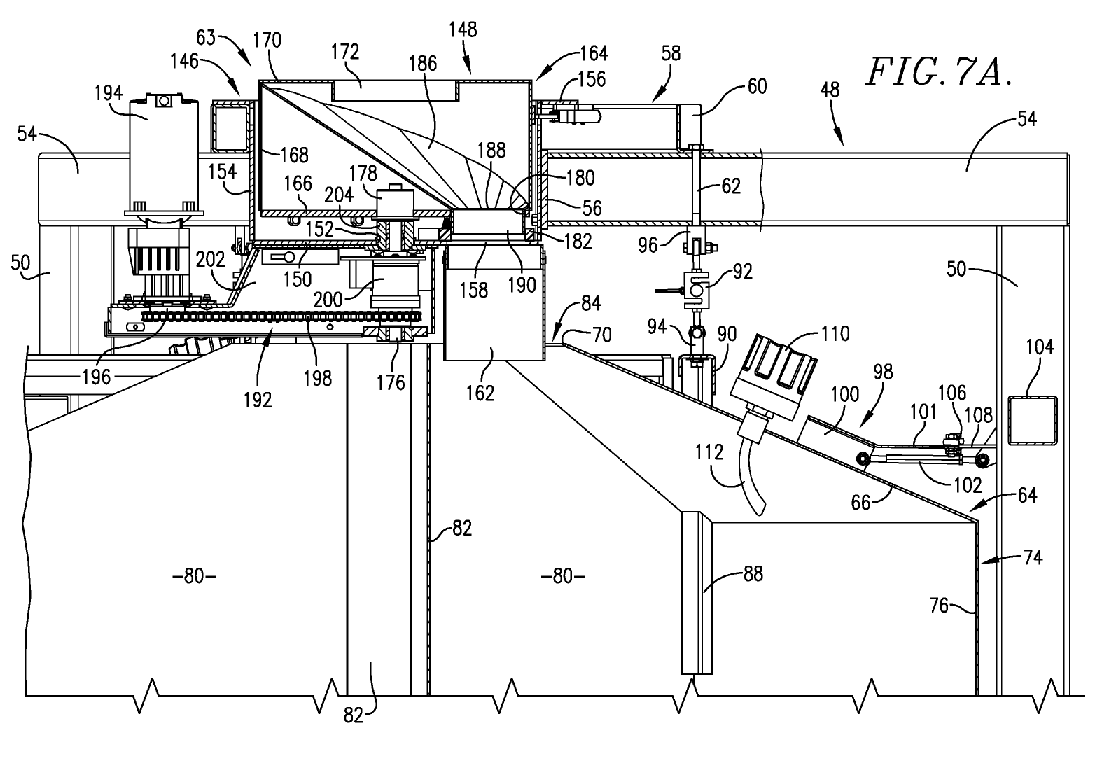

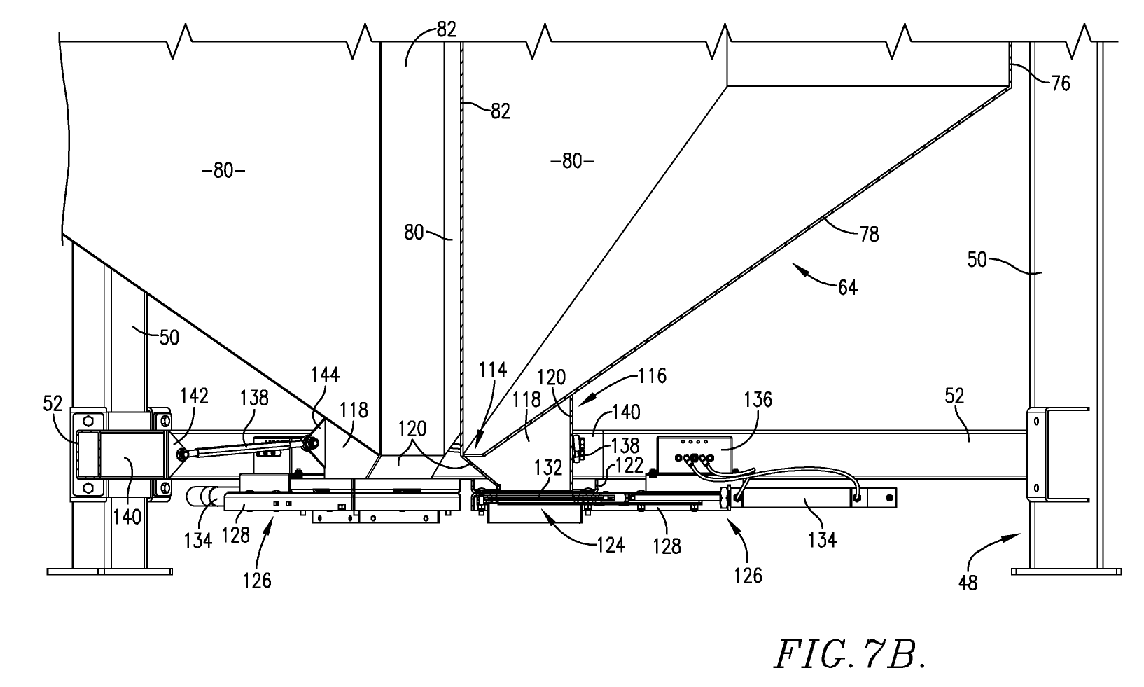

Each bin 64 is equipped with a generally U-shaped support bale 86 having upwardly extending legs 88 at the juncture between the margins 68 and 72, with a cross-rail 90 secured to the upper ends of the legs 88. A load cell 92 is secured to the cross-rail 90 by means of a lower clevis 94. The upper end of each load cell 92 is secured by means of an upper clevis 96 threaded into the lower end of the adjacent connector 62, so as to suspend each bin 64 from the associated support beam 54. In order to provide more precise weight control, a plurality of load cells 92 may be used in lieu of a single cell. A stabilizing assembly 98 is centrally secured to the upper surface of top wall 66 and includes a U-shaped body 100 and an upwardly inclined, apertured, generally triangular connector plate 101. A pair of adjustable links 102 with the remote ends thereof attached to stabilizer beams 104 affixed to the adjacent support leg 50 of frame structure 48. An adjustable link 106 is connected between the plate 101 and a flange 108 forming a part of one of the beams 104. A conventional bin-full sensor 110 is attached to top wall 66 and has an inwardly extending probe 112 (FIG. 7A).

Referring now to FIGS. 7B and 12-14, the lower outlet end of each bin 64 is depicted. Specifically, the tapered, lower arcuate sidewall section 78 has a lower opening 114. A delivery chute 116 comprising sidewalls 118 and end walls 120 depends from the lower end of the bin and has a surrounding box-like mounting flange 122. The opening 114 and delivery chute 116 thus define a lower seed bin outlet 124.

In order to selectively regulate the flow of seed from outlet 124, the bin 64 is equipped with a slide gate assembly 126. The assembly 126 includes a primary frame 128 with a through-opening 130. A selectively shiftable slide gate 132 is movable in a fore-and-aft fashion between a fully closed position blocking flow of seed through the opening 130, and a fully closed position. Each slide gate assembly 126 has a sensor for detecting whether the slide gate 132 is in a closed or open position. Movement of the slide gate 132 is effected by means of a double-acting pneumatic piston-and-cylinder assembly 134 equipped with an open slide-gate position sensor. A control valve 136 is also supported on the primary frame 128 and is operatively coupled with a pneumatic cylinder and digital controller (not shown), which controls the operation of assembly 134. As illustrated in FIGS. 13 and 14, the primary frame 128 is designed to mate with the flange 122, such that the lower seed outlet opening 124 is in registry with the through-opening 130.

In order to stabilize the lower end of the bin 64, a pair of oppositely outwardly extending adjustable links 138 are connected to chute 116 and the adjacent cross-braces 52. To this end, the cross-braces 52 are provided with central, inwardly extending stubs 140, and the links 138 are interconnected between flanges 142 on the stubs 140, and flanges 144 on the chute 116.

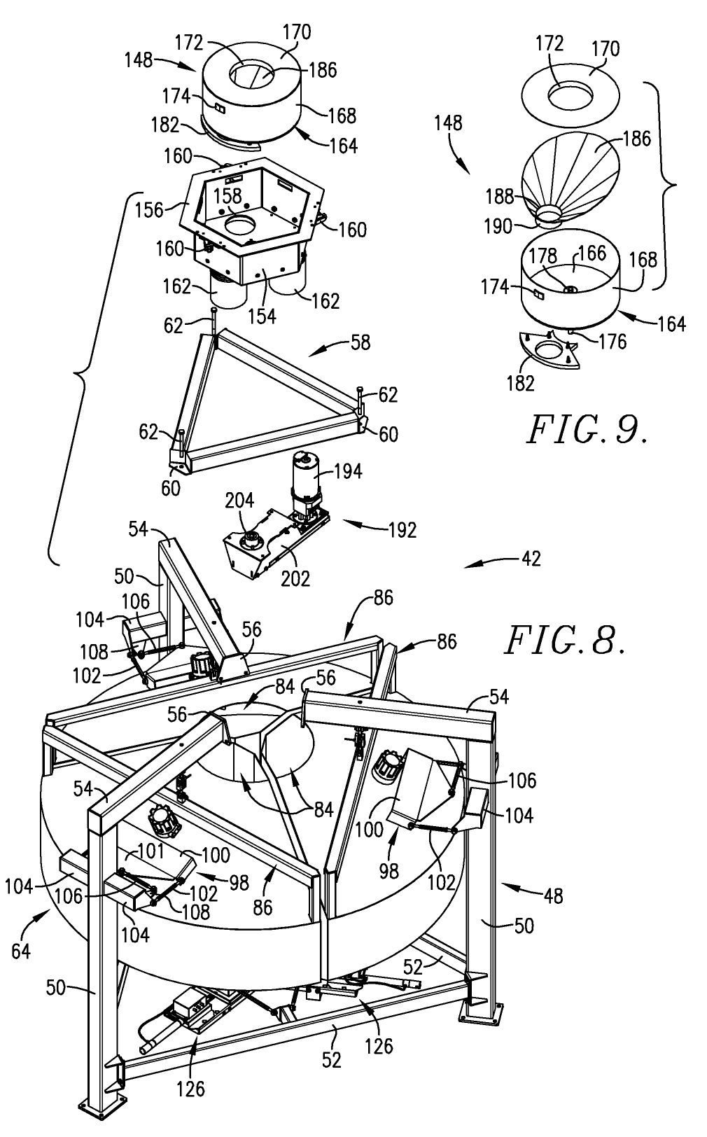

The turret assembly 63 is best illustrated in FIGS. 7A and 8. The assembly 63 generally has a stationary turret mount 146 and a rotary turret 148 within the mount. The mount 146 is hexagonal in configuration, having a bottom wall 150 equipped with a central bearing opening 152, six interconnected, upstanding sidewalls 154, and an uppermost circumscribing mounting lip 156. The bottom wall 150 has three equidistantly spaced through-openings 158. The sidewalls 154 support three equidistantly spaced location sensors 160, which are designed to sense the position of turret 148. Three flexible tubular guides 162 are secured to the underside of bottom wall 150 in registry with the corresponding openings 158. The turret mount 146 is supported on turret frame 58 with the lip 156 overlying the bars making up the frame 58.

The turret 148 comprises a cylindrical housing 164 including a bottom wall 166, upstanding, circular sidewall 168, and a top wall 170 having a central opening 172. A sensor element 174 is secured to the outer surface of sidewall 156 and is oriented to be sensed by location sensors 160. The housing 164 is equipped with a central drive shaft 176 secured by a coupler 178 and extending below bottom wall 166. The bottom wall 166 has an offset outlet opening 180, with an apertured seal plate 182 positioned below the opening 180 and in registry therewith. The seal plate 182 is secured to bottom wall 166 by means of connecting bolts 184 passing through plate 182 and threaded into bottom wall 166, with conical springs disposed about each bolt 184. An obliquely oriented chute 186 is located within housing 164 and has a lower opening 188 with a short, downwardly extending, tubular transition 190.

A drive unit 192 (FIGS. 7A and 8) is located beneath turret mount 146 and includes an electric drive motor 194 having an output sprocket 196 and a drive chain 198 trained about the sprocket 196. The chain 198 is also trained about a clutch assembly 200 receiving shaft 176.

The sprocket 196, chain 198, and clutch assembly 200 are located within a surrounding housing 202. The latter has an upstanding tubular bearing assembly 204. As best seen in FIG. 7A, the turret 148 is received with turret mount 146, with the drive shaft 176 extending through bearing assembly 204 and clutch assembly 200, such that the turret 148 is rotatable relative to the turret mount 146. Hence, the operation of motor 194 serves to rotate turret 148, as will be described in detail below.

In practice, the three bins 64 are supported in juxtaposed relationship by the frame structure 48, so that the grouped bins present a substantially circular configuration in plan. Each such bin is supported by one or more load cells 92, the latter interconnected between an upper support beam 54 and an underlying bale 86. In this orientation, the sidewalls 80 of the bins 64 are in close, parallel adjacency, and the flexible tubular guides 162 extend into the corresponding seed bin inlets 84, and the tapered sidewall sections 78 converge towards a common lower apex. The stabilizing couplers 102, 106, and 138 serve to maintain the position of the suspended beams 64 within the frame structure 48. Control of the seed bin assembly 42 is accomplished through one or more programmable digital controllers (not shown), which are connected with the aforementioned sensors, load cells 92, control valves 136, and the clutch assembly 200 forming a part of the turret drive unit 192. The controller(s) are appropriately programmed to carry out the operation of the assembly 42 in concert with the remainder of the overall system 40.

Operation of the Seed Bin Assembly 42

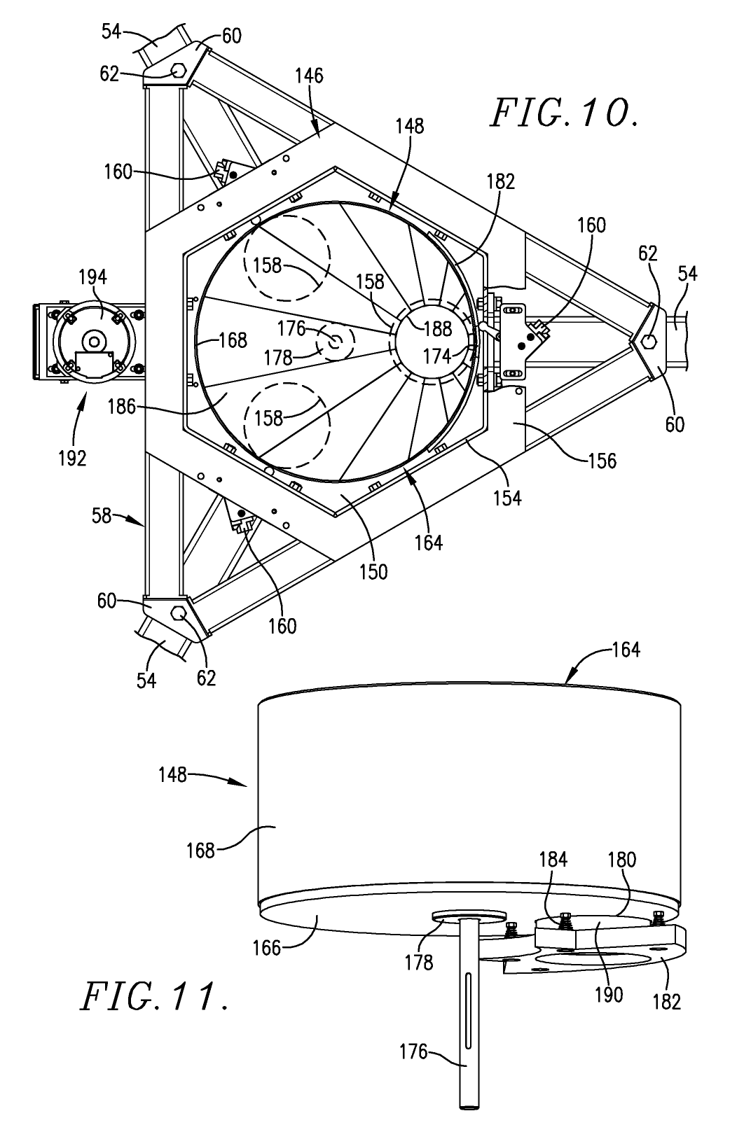

In the operation of the assembly 42, incoming seed is delivered through turret inlet opening 172 by any convenient means, such as by an inclined conveyor leading from a supply of seed to the opening 172. The incoming seed is sequentially diverted to each of the beans 64 by appropriate positioning of the rotary turret 148 within turret mount 146, so that the lower opening 188, the opening of seal plate 182, and the transition 190 of the chute 186 come into registry with one of the through-openings 158 of bottom wall 150. This is illustrated in FIGS. 7A and 10 where the opening 188 and the transition 190 are in registry with one of the openings 158, with the other two openings circumferentially spaced from the one opening 158. Seed is delivered to the associated bin 64 by passage along chute 186, through opening 188 and transition 190, and ultimately through the guide 162 into the interior of the bin. As seed accumulates within one of the bins 64, the weight of the bin is monitored by the associated load cells 92 and bin-full sensor 110. When the bin is filled to the desired degree, the turret 148 is shifted or indexed via turret drive unit 192 so that the lower opening 188 and transition 190 of turret 148 come into registry with the next adjacent opening 158 and guide 162, and the process is repeated. During such movement, the spring-biased seal plate 182 engages the upper surface of bottom wall 150. Precise positioning of the turret 148 is obtained by means of the position sensors 160 and sensor element 174. In this fashion, the turret 148 successively diverts seed into and fills the three bins 64.

Simultaneously with the stepwise filling of the bins 64, seed is delivered through the lower bin outlets 124 and slide gate assemblies 126. Flow of seed is controlled by the slide gate assemblies 126, which move between full-closed and full-opened positions. The bins 64 are filled and emptied using known loss-in-weight techniques, in cooperation with the seed wheel assembly 44, so that a substantially even supply of seed is delivered to seed treater 46. This in turn allows computation of the precise amount of seed delivered to the treater 46, thereby providing certified seed weights to a buyer, without the need for a separate weighing step.

Seed Wheel Assembly 44

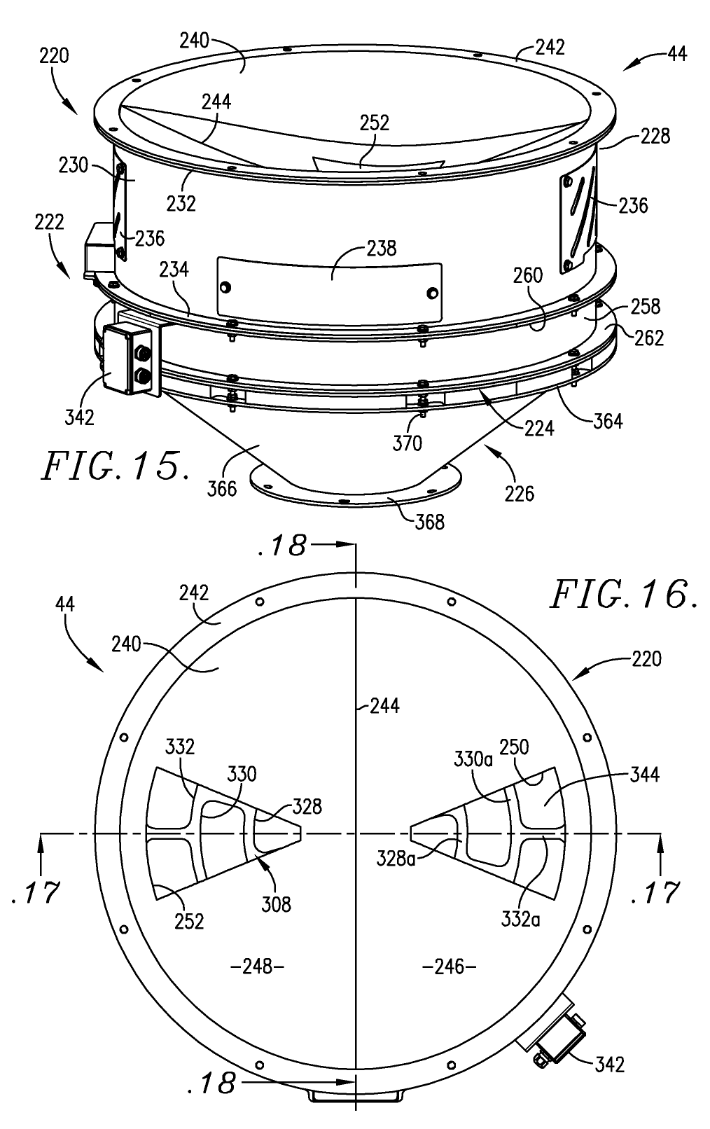

The seed metering wheel assembly 44 (FIGS. 15-16) broadly includes an uppermost hopper assembly 220, an intermediate seed metering assembly 222, a lower plate assembly 224, and a lowermost delivery chute 226.

The hopper assembly 220 includes a housing 228 having an upright tubular sidewall 230, circular upper and lower connection flanges 232, 234, a pair of opposed vents 236, and a series of removable access plates 238. A unitary seed-receiving hopper 240 having a connection flange 242 is positioned within the confines of housing 228, such that the flanges 232, 242 mate and are connected via fasteners (not shown). The hopper 240 has an arcuate center line apex 244 with identical, downwardly extending, arcuate wall sections 246, 248 each equipped with identical, generally triangularly-shaped seed opening 250 or 252; the latter have downwardly extending, defining wall structures 254, 256.

The intermediate seed metering assembly 222 is positioned below hopper assembly 220 and includes a stationary, tubular housing 258 with upper and lower connection flanges 260 and 262. The upper flange 260 mates with lower flange 234 of assembly 220, with appropriate fasteners serving to connect the flanges. The housing 258 supports a stationary channel 264, which in turn supports an electrical drive motor 266 and gear box 268. The channel 264 also supports a pair of brackets 270 and 272 at the central region thereof. A pair of identical, generally triangular weldments 274 are respectively connected to the brackets 270 and 272 and extend outwardly and are supported by the housing 258. The weldments 274 each include a pair of diverging box sidewalls 276, 278, 280, 282, as well as an outboard spacer 284 or 286 and fasteners 288, 290, 292, 294. Seed sensors 296, 298 are respectively connected with the box sidewalls 276 and 280. A lowermost, radially extending brush 300 is secured to sidewall 278, and an identical brush 302 is secured to sidewall 282. It will be observed that the weldments 274 each define a substantially triangular through-opening 304 or 306 and are respectively in registry with the seed outlet openings 250 and 252 of hopper assembly 220. It will thus be appreciated that the openings 304, 306 are seed entrance openings for the intermediate metering assembly 222.

The overall assembly 222 also includes an axially rotatable metering wheel 308, which is situated within the confines of housing 258. The wheel 308 is of composite design and has a series of interconnected, apertured plates, namely an upper synthetic resin wheel plate 310, an intermediate stainless steel reinforcing plate 312, and a lower synthetic resin plate 314. A circumscribing, outwardly extending seed retaining ring 316 surrounds the apertured plates and extends above the upper surface of plate 310. The interconnected plates 310-316 have a central, hexagonal drive opening 318 and a series of seed metering openings 320 therethrough. In detail, the openings 320 are arranged in a total of three circular arrays 322, 324, and 326. The inner array 326 has a plurality of identical, triangular through-openings 328; the intermediate array 324 has a plurality of elongated, arcuate openings 330, which are in staggered relationship relative to the openings 328. Finally, the outer array 322 has another series of identical, elongated, arcuate openings 332, which are staggered relative to the openings 330 of the intermediate array. It will further be observed that the openings 328, 330, and 332 are each defined by circumscribing rib sections 328a, 330a, and 332a.

The metering wheel 308 is rotated in a clockwise direction as viewed in FIG. 16, by means of the drive motor 266 and gear box 268. The box 268 has an elongated, hexagonal, vertically extending, rotatable drive shaft 334 with a lowermost, downwardly extending, threaded shank 336 extending below the wheel 308. The shaft 334 and hub 338 serve to rotate the wheel 308, with the shaft 334 received within the central drive opening 318. The operation of motor 266 is controlled by means of conventional wiring including electrical leads 340 and junction box 342 connected to a digital controller (not shown). Plate assembly 224 is stationary and includes an upper metallic wear plate 344, which engages the lower surface of wheel 308, a synthetic resin foam support pad 346, and a lowermost, metallic floor plate 348. The plates 344 and 346 have identical, opposed, outwardly diverging slots 350, 352, whereas floor plate 348 has similarly configured through-openings 354. The wear plate 344 has a pair of downwardly extending flanges 356 adjacent to the edges of openings 350, which direct seed downwardly as the seed exits the assembly 224. The assembly 224 is mounted on shank 336, and an elongated bearing plate 358, washer 360, and nut 362 are used to mount the assembly 224. The delivery chute 226 is generally frustoconical and has an uppermost connection flange 364, a tapered hollow body section 366, and a lowermost connection flange 368. The flange 364 is connected to the underside of plate assembly 224 by means of elongated connectors 370.

As is evident from the foregoing description, the seed wheel metering assembly 44 provides a hopper for receiving seeds to be treated, with the seeds flowing by gravitation through the seed openings 250 and 252, and then through the underlying weldment openings 304 and 306, where the seed encounter the metering wheel 308. After passage through the metering wheel 308, the seeds pass through the stationery openings 350, 352, and 354 of plate assembly 224, for downstream processing.

The passage of seed through meter wheel 308 is of prime importance. That is, as the wheel 308 rotates, the especially-designed and configured seed metering openings 328, 330, and 322, and the corresponding openings 328, 330, and 332 continually present a substantially constant open area. That is to say, at virtually every such instance over a given time period, the wheel 308 presents an effective through-opening which is of a substantially constant area. Furthermore, owing to the preferred, differently sized openings 328-332, the staggered orientation thereof, and the locations of the defining-rib sections 328a-332a, at no instance is there a wholly unobstructed seed flow path through the wheel 308. As such, the tendency of prior spoke-type seed metering wheels to cause a buildup of seed, followed by presentation of a completely unobstructed seed flow path with consequent surging or “dumping” of seed, is substantially eliminated. The presence of the stationery brushes 300 and 302 assist in the desirable operation of the metering wheel 308, by acting as a leveling device, in order to successively level the upper surfaces of quantities of seeds retained by the ring 316, so that substantially constant seed weights are present at the inlet face of the metering wheel 308. Consequently, the seed metering wheel assembly 44 provides a substantially constant weight and volumetric flow of seed to the down-stream seed treater.

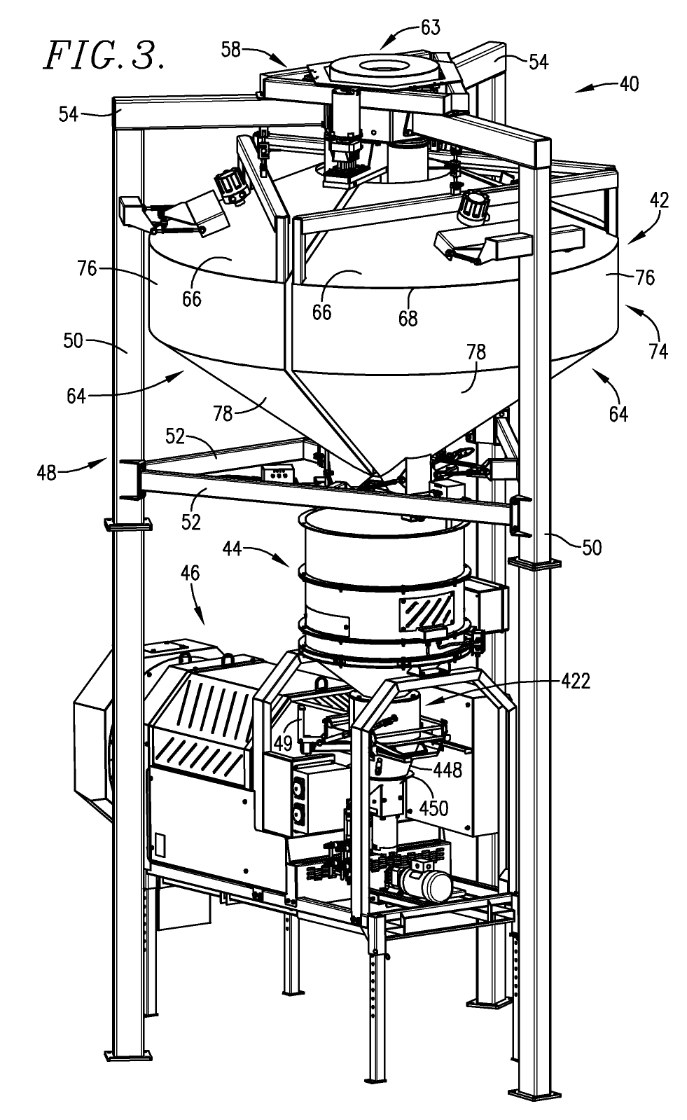

As illustrated in FIG. 3, the system 40 may also be equipped with an auxiliary, manually operated rotary gate assembly below seed wheel assembly 44, which is identical with the gate assembly 422 described below, except that the auxiliary gate assembly is manually operated by means of a control lever 49 (FIG. 3) instead of the piston and cylinder actuator 442, to open the gate to the desired extent. This auxiliary gate can be useful in order to assure that an even flow of seeds is delivered to the treater 46.

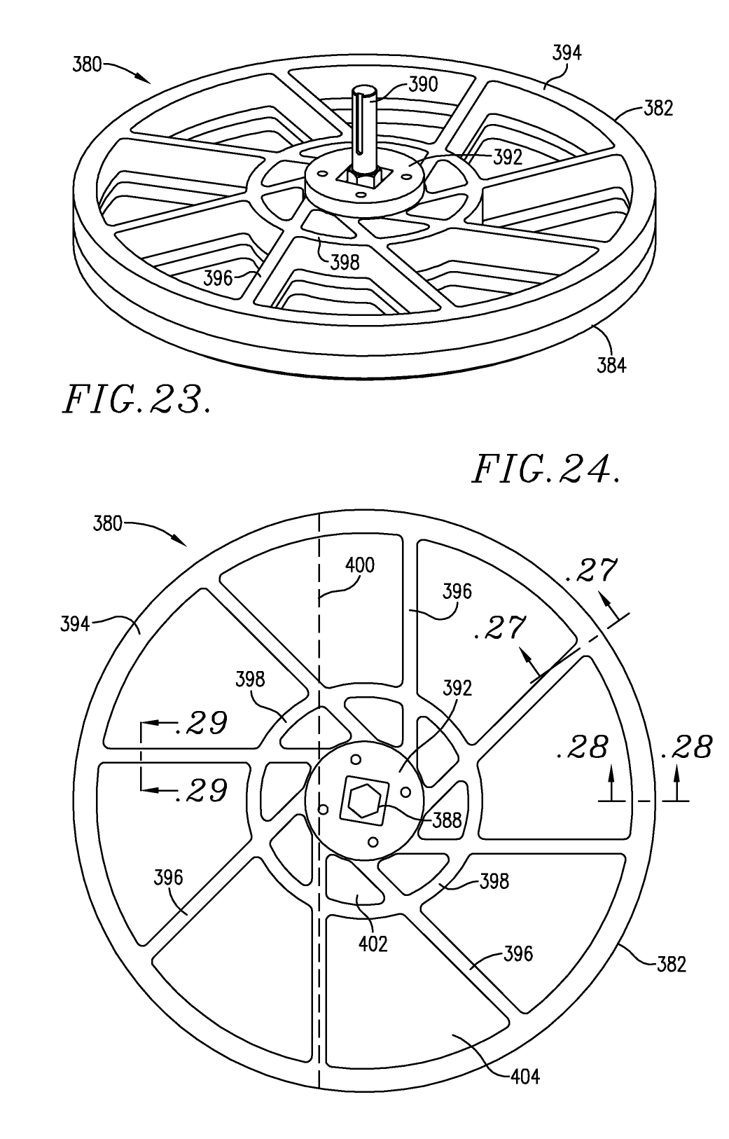

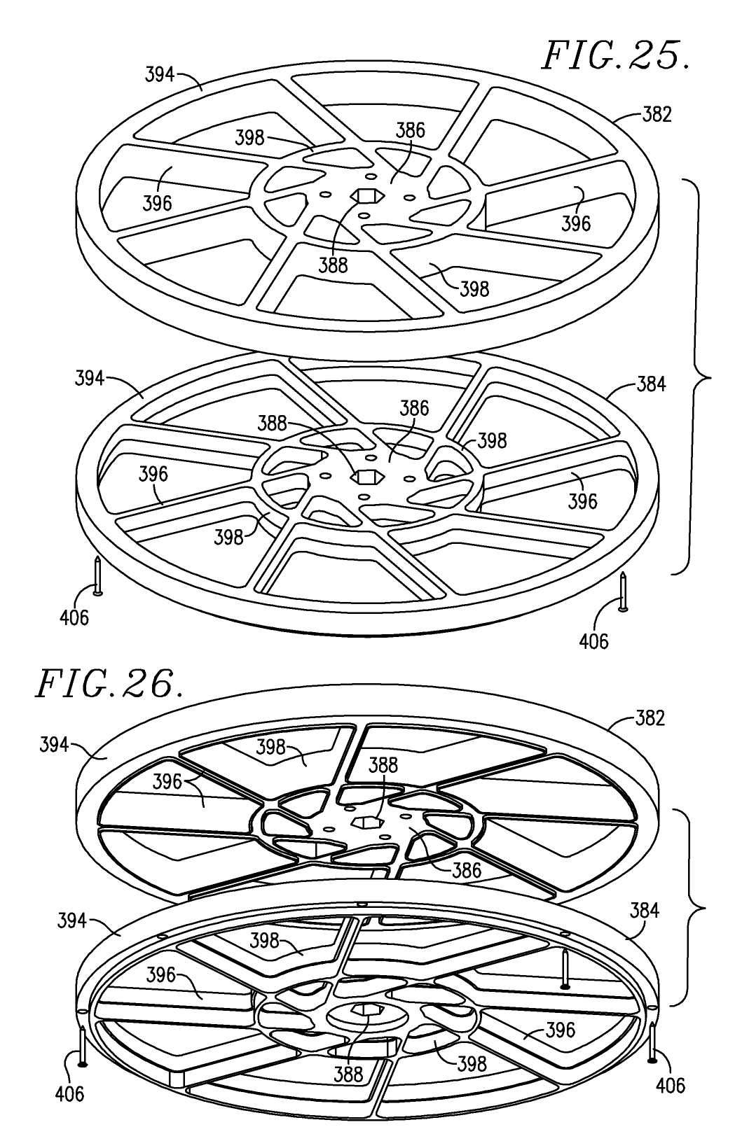

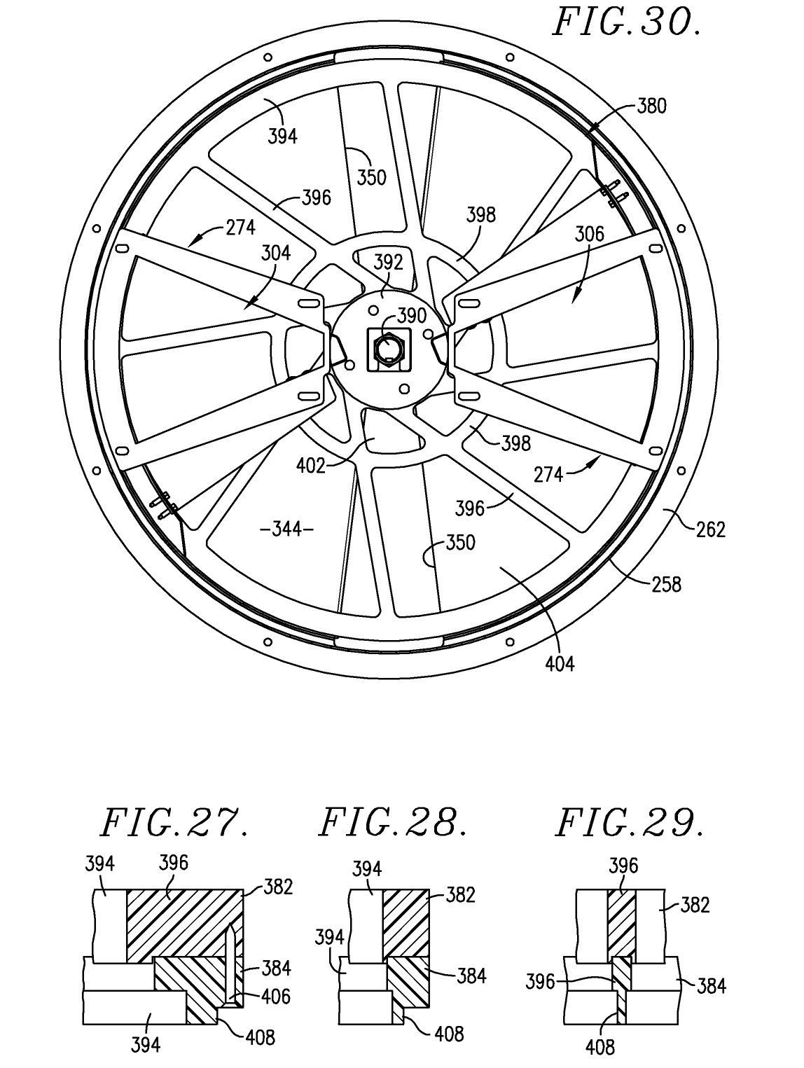

Alternate Seed Metering Wheel of FIGS. 23-30

Turning now to FIGS. 23 - 29, a seed metering wheel 380 is depicted. The seed metering wheel 380 has a different design as compared with the previously described seed metering wheel 308, but is configured for use within the overall assembly 44. The wheel 380 is a simpler design, which can be manufactured at a lower cost as compared with the wheel 308.

In particular, the wheel 380 is of composite design, comprising upper and lower, interconnected, synthetic resin wheel plates 382, 384. The interconnected plates, 382, 384, cooperatively define a central hub 386 having a hexagonal drive opening 388. As illustrated in FIG. 23, a rotatable drive shaft 390 identical with the previously-described shaft 334, extends into the opening 388 in order to rotate wheel 380 by means of motor 266 and gear box 268. To this end, hub plate 392 also forms a part of the drive assembly for the wheel 380.

The overall wheel 380 includes an outermost rim 394, a total of eight elongated ribs 396 which extends from central hub 386 to rim 394, and a circular reinforcing ring 398 between hub 386 and rim 394. It will be observed that the ribs 396 lie along respective, non-diameter chord lines 400 (FIG. 24) which are equally spaced about the wheel 380. In this fashion, the wheel 380 presents a series of eight somewhat triangular inner openings 402 between central hub 386 and reinforcing ring 398, and eight larger, generally quadrate openings 404, each outboard of an opening 402 and located between ring 398 and rim 394.

In more detail, it will be seen that plates 382 and 384 are in face-to-face contact, and are interconnected by means of screws 406. As best illustrated in FIGS. 26-29, the lower wheel plate 384 has a reduced thickness, downwardly extending circular contact lip 408 forming a part of rim 394; likewise, the lower extent of the ribs 396 are of reduced thickness. Stated otherwise, the thickness of the lower edge of the lower plate 384 is thinner than the thickness of the upper edge of the upper plate 382. These features serve to reduce the friction between the wheel 380 and the underlying structure of the assembly 46, while also providing sufficient mechanical strength for the wheel.

As explained previously, the wheel 380 is an alternate design, which is fully compatible with the other components of assembly 44. This is best illustrated in FIG. 30, which depicts the weldments 274 defining the through-openings 304, 306 serving as seed entrance openings for the wheel 280.

The operation of wheel 380 is exactly as previously described in connection with wheel 308. During such operation, at virtually every instance over a given period of time, the wheel 380 had effective-through openings of substantially constant area, and in no instance is there a wholly unobstructed seed flow path through the wheel 380.

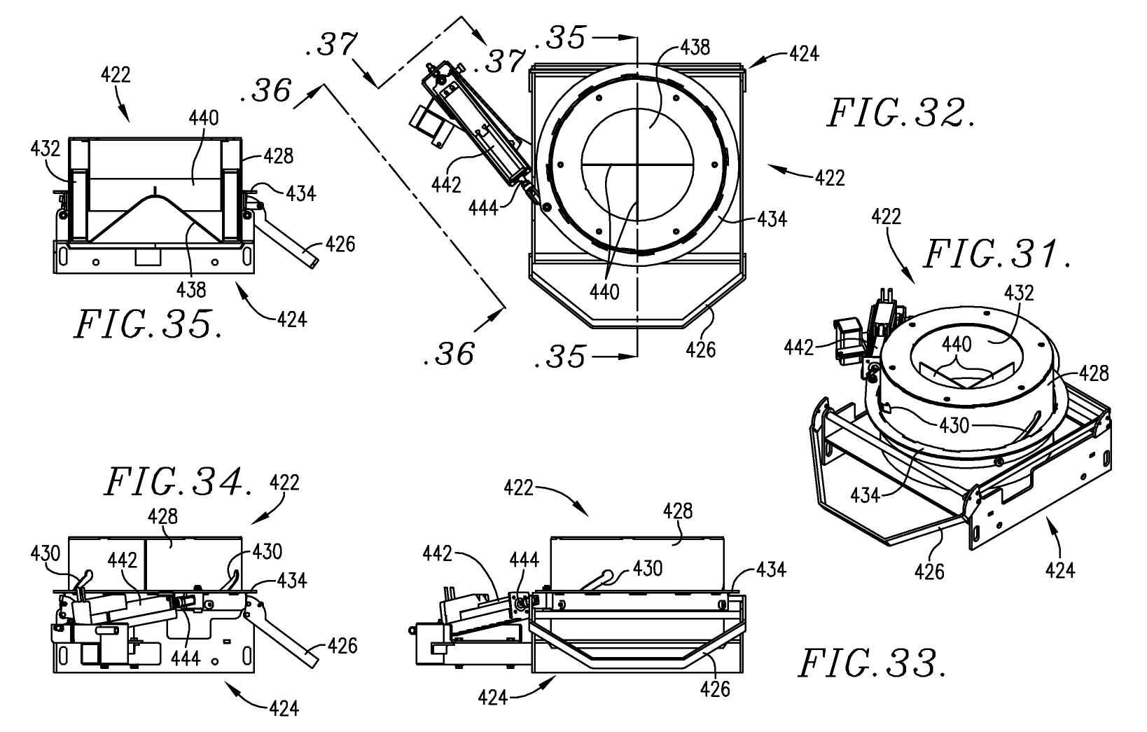

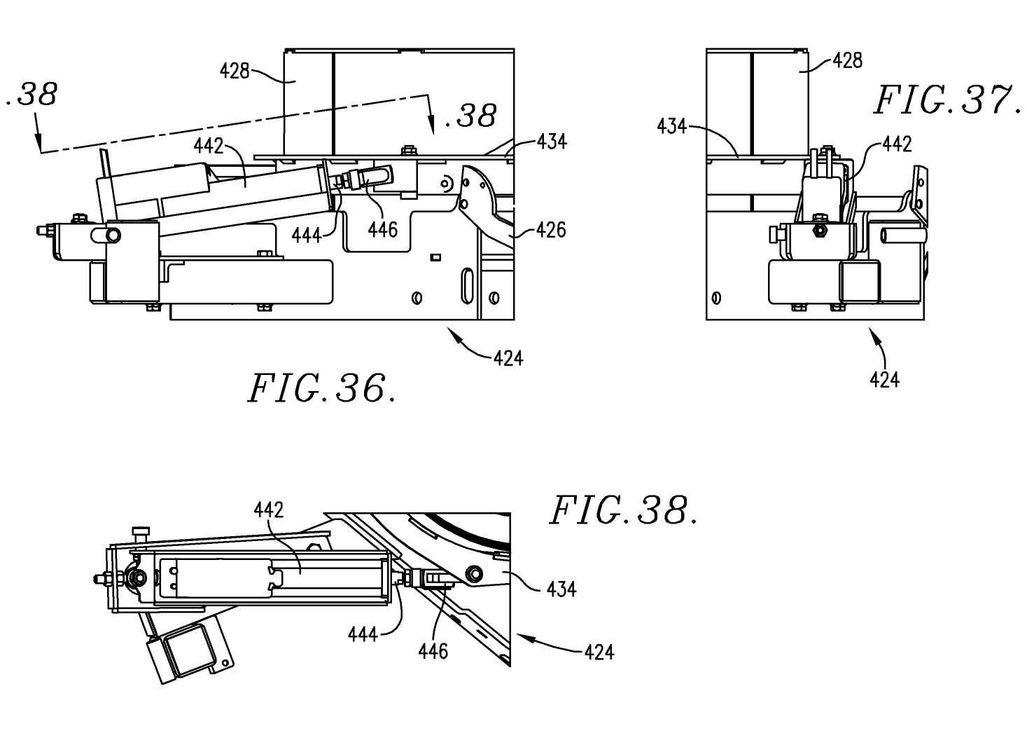

### Embodiment of FIGS. 2 and 31-38

FIG. 2 is similar in many respects to FIG. 1, and depicts a seed handling assembly 420 making use of a rotary gate assembly 422 in lieu of the seed wheel assembly 44 of the first embodiment. The assembly 420 includes a box-like support structure 424 having a lever lock 426 permitting interconnection between the underside of seed bin assembly 42 and seed treater 46. A circular outer wall 428 extends upwardly from support structure 424 and includes three circumferentially spaced apart oblique cam slots 430. A rotatable gate 432, provided with an outwardly extending flange 434, is provided inboard of the wall 428 and is designed to move between a fully closed position of FIG. 35 to an open position wherein seed will flow through the assembly 420. An internal diverter assembly 436 is located within the confines of gate 432, and includes a lower, substantially conical seed diverter 438, and upper diverter cross walls 440.

A piston and cylinder actuator 442 is positioned outboard of the gate 432 and includes a reciprocal piston rod 444 having an endmost clevis 446. The clevis 446 is operatively connected to flange 434, as best seen in FIG. 38. Three cam bushings (not shown) are secured to gate 432 and are respectively located within a cam slot 430. When it is desired to open the assembly 422, the actuator 442 is energized to extend the rod 444. This serves to rotate the gate 432 to the desired extent, with the cam bushings riding within the slots 430. Such gate rotation creates a gap below gate 432 to permit seed flow. It will be appreciated that the diverter assembly 436 serves to divide and divert down-coming seeds outwardly towards the circular gap created upon rotation of gate 432.

In operation, the gate assembly is controlled using the loss-in-weight data from the bin assembly 42. Typically, at the outset of a seed coating run, the gate assembly 422 is opened to a known extent (e.g. 50%), and the loss-in-weight data is used to determine the initial flow rate. Thereafter, the gate assembly 422 is adjusted by operation of the actuator 442 to raise or lower the gate 432 to achieve the desired flow rate which matches that of the flow rate of liquid chemical(s) to the seed treater, described below.

### Seed Treater 46

Seed treater 46 is illustrated in FIGS. 1-3, and is itself entirely conventional. The treater 46 and upper, open-top inlet 448 which mates with the lower outlet ends of the seed wheel assembly 44 or gate assembly 422, as the case may be. Inlet 448 includes an atomizer housing 450 containing a conventional atomizer for the coating of seeds passing through the inlet. The coated seed exiting housing 450 passes into a treating chamber 454, where the seed is tumbled and dried. The finally coated seed is then directed to an outlet chute 456. Coating chemicals are delivered to the atomizer within housing 450 by known means, typically through the use of a controlled pump, at known rates correlated with the rate of incoming seed from the bin assembly 42 and either seed wheel assembly 40 or gate assembly 422. Such seed treaters can be obtained from USC, L.L.C. of Sabetha, Kans.

FIG. 39 is a schematic representation of a generalized seed treating system 458 in accordance with the invention. The system 458 includes a seed bin assembly 460 having one or more bins, a downstream seed metering device 462 (e.g., a seed metering wheel assembly or a rotary gate assembly), and a seed treater 464. The seed treater includes a supply 466 of coating liquid together with a pump for delivering the liquid to the treater as described. Incoming seed is delivered to the bin(s) 460, which then passes through devices 462 and is treated within treater 464, creating a coated seed output 468.

Overall Seed Treating System

The system 458 is preferably electronically controlled using a digital control device, such as a computer or programmable logic controller (PLC) 470. Data links 472, 474, and 476 respectively couple the controller 470 with the seed bins(s) 460, device 462, and the coating liquid pump. Thus, the necessary data from seed bin(s) 460 is conveyed via link 472 and appropriate loss-in-weight determinations are made via the controller. This information is used at least in part to control the operation of device 462, and also to control the output from the coating liquid pump. Although the controller 470 has been illustrated as a single device, it will be understood that each of the system components may include its own controller(s), which would then be linked to a master controller.

As indicated above, the invention is not limited to the treatment of seeds, but extends to any appropriate particulate material. Thus, the system 458 can be used in a variety of contexts, but is particularly suitable for seed coating operations.

We claim:

1. A particulate material treating system comprising:
a loss-in-weight bin assembly operable to deliver particulates at known flow rates over time from a bin assembly output;
a particulate material metering device operably coupled with said bin assembly output for metering the flow of said seed therethrough; and
a particulate material treater downstream of said metering device and operable to receive particulate material therefrom.

2. The system of claim 1, said bin assembly comprising a plurality of individual bins.

3. The system of claim 1, said metering device comprising a rotatable seed wheel.

4. The system of claim 1, said metering device comprising an adjustable flow gate assembly.

5. The system of claim 1, said particulate material being seeds, said particulate material treater being a seed coater.

6. A method of treating particulate material comprising the steps of:
establishing a flow of particulate material from a particulate material bin assembly, and determining the flow rates of the material from the bin assembly over time as a function of the loss of weight of the bin assembly;
metering said flow of particulate material using a metering device to establish a constant flow rate of the material over time; and
treating the metered flow of said particulate material.

7. The method of claim 6, said particulate material being seed.

8. The method of claim 6, including the step of using an electronic controller to determine said flow rates and to adjust the operation of said metering device to establish said constant flow rate of material over time.

9. The method of claim 6, including the step of using a seed metering wheel for said metering step.

10. The method of claim 6, including the step of using an adjustable gate device for said metering step.

11. The method of claim 6, said treating step comprising the step of coating said particulate material.
